(19) United States
(12) Patent Application Publication
(10) Pub. No.: US 2023/0081588 A1
(43) Pub. Date: Mar. 16, 2023

(54) Systems and Methods for Merging Pictures Taken with Different Computing Devices and Having a Common Background

(71) Applicant: Groupixx, Inc., Opelika, AL (US)

(72) Inventors: Alzata R. Florence, Opelika, AL (US); Joe Norris, Opelika, AL (US)

(73) Assignee: Groupixx, Inc., Opelika, AL (US)

(21) Appl. No.: 17/889,785

(22) Filed: Aug. 17, 2022

Related U.S. Application Data
(60) Provisional application No. 63/339,125, filed on May 6, 2022.
(60) Provisional application No. 63/233,935, filed on Aug. 17, 2021.

(51) Int. Cl. G06T 5/50; G06T 11/60; G06T 1/00; G06Q 50/00; H04L 51/04

(52) U.S. Cl. CPC G06T 5/50; G06T 11/60; G06T 1/0021; G06Q 50/01; H04L 51/04; G06T 2207/20221

(57) ABSTRACT

A system that has a first computing device and a second computing device communicatively coupled to the first computing device via a network. The system further has a processor on the first computing device operated by a host user and sends an invitation to an invitee user to take a picture of himself/herself. The processor also receives a first photograph from the invitee user and merges the first photograph of the invitee user with a second photograph of the host user creating a merged photograph. The processor also can share the merged photograph with other invitee users or social media.

### CROSS-REFERENCE TO RELATED APPLICATIONS

This application claims priority to U.S. Provisional Patent Application Ser. No. 63/233,935 entitled This App Will Be Able to Take a Group Picture {Portrait} of several people from Different Places at the Same Time and filed on Aug. 17, 2021 and U.S. Provisional Patent Application Ser. No. 63/339,125 entitled Systems and Methods for Merging Pictures Taken with Different Computing Devices and Having a Common Background and filed on May 6, 2022, both of which are incorporated by reference.

### BACKGROUND

Most people today have smartphones. A smartphone is any type of device that is a mobile phone. The smartphone performs functions like a computer. It typically has a touchscreen interface, internet access, and an operating system that runs applications. Further, most smartphones have one more camera with which the user can take photographs, including selfies.

A selfie is a photograph that one has taken of oneself. Typically, the person takes the selfie a smartphone and shares via social media, e.g., Facebook®. Often, a selfie is a self-portrait that the person takes with the camera at arm's length. A selfie, however, may include multiple subjects, if one of the subject's featured takes the photograph.

### BRIEF DRAWING DESCRIPTIONS

A reader of the detailed description of the present disclosure best understands the present disclosure with reference to the following drawings. The elements of the drawings are not necessarily to scale relative to each other, emphasis instead placed upon clearly illustrating the principles of the present disclosure. Furthermore, like reference numerals designate corresponding parts throughout the views.

FIG. 1 is an exemplary system for merging pictures taken with different computing devices and having a common background in accordance with the present disclosure.

FIG. 2 is a computing device such as shown in FIG. 1 showing a main menu.

FIG. 3 is a block diagram of an exemplary first computing device such as shown in FIG. 1.

FIG. 4 is a block diagram of an exemplary second computing device such as shown in FIG. 1.

FIG. 5 is a flowchart of exemplary architecture and functionality of the sign in and sign-up modules of the system such as shown in FIG. 1.

FIG. 6 is a flowchart of exemplary architecture and functionality of the top menu of the system such as shown in FIG. 1.

FIG. 7 is a flowchart of exemplary architecture and functionality of the main page of the system such as shown in FIG. 1.

FIG. 8 is a flowchart of exemplary architecture and functionality of the bottom menu of the system such as shown in FIG. 1.

### DETAILED DESCRIPTION

The present disclosure is a system that comprises at least two computing devices. The two at least computing devices may be, for example, computers, laptops, tablets, smartphones, and the like. A host user of a first computing device transmits a silhouette to an invitee user of a second computing device. The invitee user of the remote computing device selects where on the silhouette the invitee user desires his/her picture to appear. Transmitted to the first computing device is data indicative of a position at which the invitee desires to appear in the merged photograph.

The first computing device begins duplicating a countdown on the second computing device from remote computing device. At the end of the countdown, the host user and the invitee user simultaneously take a picture with their respective computing devices. The photograph taken on the he second computing device transmits the photograph taken to the first computing device.

Upon receipt of the remote position and the remote photograph from the remote computing device, the first computing device merges the picture of the invitee user at the position selected on a background selected by the host user. The first computing device also merges the host user's picture at the position selected on the background spatially in a different place than the invitee user position. Thus, the first computing device creates a photograph of the first and second computing device users on a background even though the host user is remote from the invitee user.

In one embodiment, the invitee user's computing device does not have the requisite functionality to execute the photograph merge. In such a scenario, the control logic 303 invites an invitee user to receive the functionality for performing the photograph merge. If the invitee user desires the functionality for performing the photograph merge by downloading an application, the invitee user selects an “OK” or a “YES” button, and the remote computing device downloads the application needed to perform the functionality.

In another embodiment, the software may have chat functionality. In this regard, the first use may initiate a chat with the invitee user via the computing devices. If the invitee user desires to chat, he/she may enter data in response to the host user's chat and transmit it to the host user's computing device.

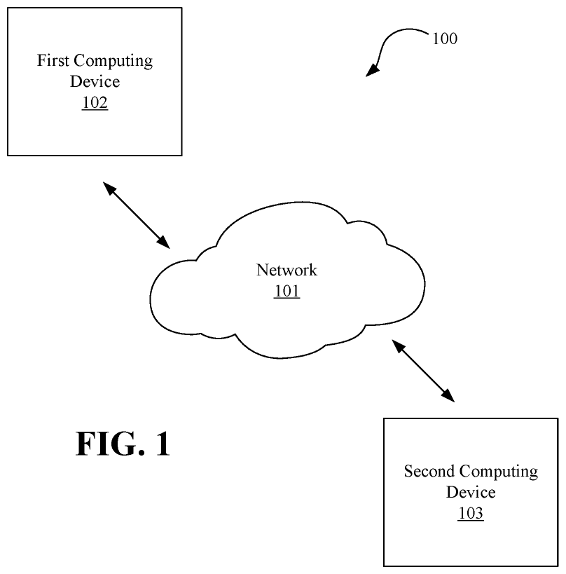

FIG. 1 is a block diagram of an exemplary photograph merge system 100 in accordance with an embodiment of the present disclosure. The photograph merge system 100 comprises at least two computing devices, including a first computing device 102 and a remote computing device 103. Note that the system 100 can have additional computing devices in other embodiments.

The first computing devices 102 and the remote computing devices 103 communicatively couple via a network 101. That is, the first computing device 102 can transmit data to the remote computing device 103 via the network 101, and the remote computing device 103 can transmit data to the first computing device 102 via the network 101.

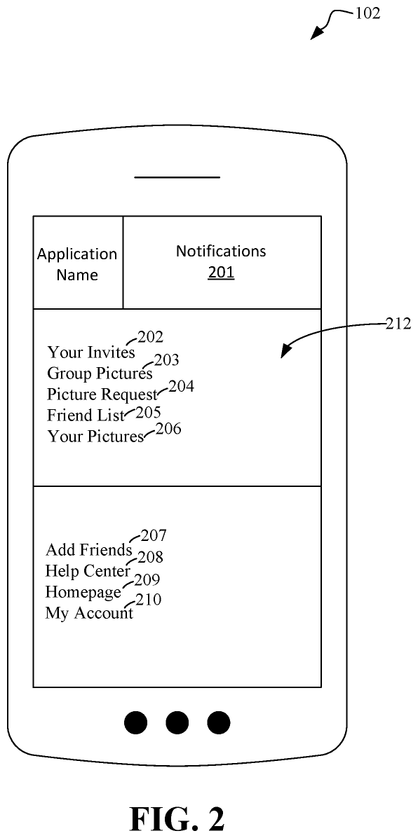

FIG. 2 is a diagram of an exemplary first computing device 102 in accordance with an embodiment of the present disclosure. While the first computing device 102 shown is a mobile device, the first computing device 102 may also be computers, laptops, tablets, or the like.

The first computing device 102 comprises a housing 208 and a display device 212. The display device 212 can be any type of display device known in the art or future developed. In this regard, the display device 201 may be a liquid crystal display (LCD), an organic light emitting diode (OLED), active-matrix organic light emitting diode (AMOLED), a Super AMOLED, a thin film transistor (ITT) light emitting diode (LED), or an in-plane switching (IPS) LED.

If the host or invitee user of the first computing device 102 and the second computing device 103 (FIG. 1), respectively, is a first-time user or the user of the second computing device 103 is a first-time user, the first-time users create an account. In this regard, the first computing device 102 and the second computing device 103 receive data input by the respective user via the display device data including, but not limited to user's full name, phone number, email address, password, and one-time password or onetime pin (OTP). Followed by a successful login, he user's email receives the OTP.

If the user already registered for an account, the computing devices 102, 103 display a login graphical user interface (GUI). Here, the user enters his/her login credentials, including a username and a password for example. In response, the computing devices 102, 103 fetch the user's login credentials and directs the user to a main home page 212 shown in FIG. 2.

Notably, FIG. 2 is an exemplary representation of the main home page 212. In this regard, the main home page 212 displays the name of the application. Further, the main home page 212 displays Notifications 201. If the host user has received notifications, the display displays such notifications upon selection of Notification 201.

In operation, the host user of the first computing device 102 selects the “Friend. List” 205, and the host user selects friends from the “Friend. List” 205 with whom the host user desires to have group pictures. The host user then selects “Group Pictures” 203.

The first computing device 102 displays three options, including: 1) Time: the host user can give a fixed time to all friends to click picture within that time duration like 2 hours, 8 hours, or 24 hours, it can be anytime; Dress Code: the host user may send information of dress color in which friends have to click the picture; and Body Size: the host user can send details about what part of the body friends have to include when taken a photograph, for example full body picture, half body picture, or face only.

Thereafter, the host user sends an invite to the friends the user desires to have in the picture by clicking a picture request 204. After inviting friends to take a picture, the countdown starts, which can be a count of five like 5, 4, 3, 2, and 1. The user takes a picture of himself/herself, and the control logic 303 save the photograph in your invites 202. Further, the first computing device 102 transmits a request for a group picture to the friends selected. As each friend clicks a picture, the control logic 303 receives a notification, and the control logic 303 notifies the host user of the first computing device 102 via notifications 201.

Within a prescribed amount of time, chosen by the host user, the host user will receive all images provided by the selected friends. The control logic 303 merges the picture(s) provided by friend(s) and the user's picture to form a single photograph.

Note that your pictures 206 is a repository for all group pictures that resulting from a merged. Further, add friends enables the host user to add friends to the friend list 205. The homepage 209 enables the host user to navigate to the host user's homepage. Finally, my account 210 enables a host user to manage his/her application account.

Whenever the invitee user gets a picture invitation, the invitee user gets the below options: 1) Time Left: the time he/she has for sending pictures; Dress code: dress color requested by friend or other invitee user; and Body size: full or half or face, for example.

If the recipient of the invitation, the recipient will use option to take photo The recipient clicks on a submit button (not shown), and the camera opens after a countdown from 5 to 1. The recipient takes a picture, if recipient likes the photo recipient may continue further or recipient can delete that image and take it again

After recipient takes a photograph, the recipient sends the photo to the host user. When the host user (the host user requesting the photograph) has completed changes in the group photo (like setting the background and pasted the shared pictures) the host user and the invitee users may access the photograph created.

In one embodiment, the host user of the first computing device 102 clicks on your invites 202. After clicking your invites, the host user obtains detailed information of the friends. For example, the host user may get data, such as date, name of friend, and time of the taking of the photograph, from the friends that respond to the group pictures 203.

Within your invites 202, the host user presses a select button (not shown). Upon selecting the select button, the first computing device 102 directs the host user to al the photographs received from invited friends. At this point in the process, the host user can either drag down a photo from a mobile gallery, click a live photo immediately (invitee user opens the camera and clicks the photo), or drag down friends' photos from the received section.

The host user may add a background to a merged photograph. In this regard, a predefined background, which the host user uploads via an administration panel (not shown). Also, the host user can change the background according to the purpose of the photograph or otherwise.

The host user can zoom in and zoom out on a merged photograph. Further, the host user has a pen option so that the host user can sign or write messages or words on the photograph, such as a watermark. Once the control logic 303 creates the photograph, the host user can share the merged photograph with the invitee friends and with social media.

In one embodiment, the application has an instant picture option. If the host user selects instant picture, the host user selects a background for the photograph. After selecting the background, the host user can select a friend from friend list and send a group picture invitation. After sending a request every friend gets a notification, and the host user can go to a waiting room where he/she can select his/her position in the photograph.

Once any invitee user comes to the app, the invitee user can see what positions remain vacant. The invitee user can select a position at which the invitee user desires to appear. Once all friends enter the waiting room and select positions for themselves, the host user can press the click button and a timer will starts with countdown—5.4.3.2.1. At the same moment, each invitee user takes a photograph, and the control logic 405 sends the photograph to the first computing device 102, where control logic 303 clears backgrounds from all pictures and placed on the background which the host user selects. Every invitee user and the host user receive a merged picture, and it is shareable. Note that while host and invitees are in the waiting room, they can chat.

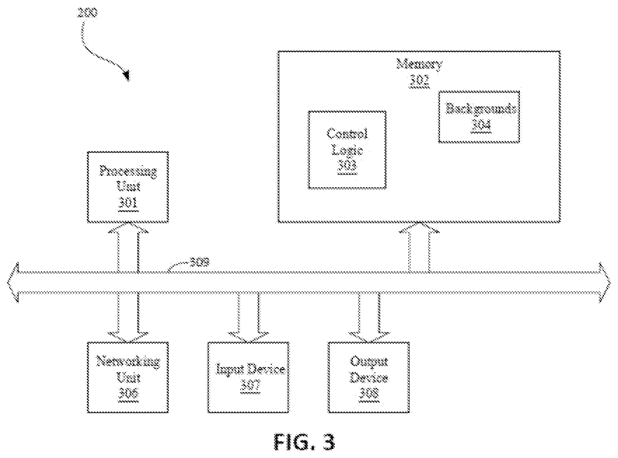

FIG. 3 is a block diagram of an exemplary first computing device 102 depicted in FIG. 2. The first computing device 102 comprises a processor 301, a network interface 306, and memory 302. Stored in memory 302 is first computing device control logic 303 and data indicative of backgrounds 304.

Note that memory 302 is any type of memory known in the art and future developed. The memory 302 represents primary memory and secondary memory. For example, memory 302 may include primary memory, such as random-access memory (RAM) (not shown) or read only memory (ROM) (not shown). Additionally, the memory 302 may include secondary memory such as, a hard drive (not shown) or a compact disc (CD) (not shown). Memory 302 may also include cache.

The exemplary embodiment of the first computing device 102 depicted by FIG. 2 comprises the at least one processing unit 301, such as a Digital Signal Processor (DSP) or a Central Processing Unit (CPU), that communicates to and drives the other elements within the first computing device 102 via a local interface 309, which can include at least one bus. Further, the processing unit 301 executes instructions of software, such as the first computing device control logic 303.

The first computing device control logic 303 controls the functionality of the first computing device 102, as described in more detail hereafter. Notably, the first computing implements the device control logic 303 in software, hardware, firmware, or any combination thereof. In an exemplary embodiment illustrated in FIG. 3, the first computing device control logic 303 is implemented in software and stored in memory 302.

Note that the first computing device control logic 303, when implemented in software, stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The first computing device control logic 303 controls the first computing device 102, which is described herein. In this regard, the first computing device control logic 303 receives inputs, transmits outputs, and displays data.

The data indicative of backgrounds 304 is accessible by the first computing device control logic 303, which enables the first computing device control logic 303 to execute photograph merging.

The networking unit 306 is any type of networking unit 306 that enables the first computing device control logic 303 to communicate with the network 101 (FIG. 1). Through the networking unit 306, the first computing device control logic 303 can communicate with the other computing devices, e.g., 102 (FIG. 1) on the network 101.

The first computing device 102 further comprises an input device 307. The input device 307 may be, for example, a microphone (not shown) or a touchscreen (not shown). The input device 307 is any type of device that allows the host user to input data into the first computing device 102.

The first computing device 102 further comprises an output device 308. The output device 308 may be a speaker or a display device 201 (FIG. 1). The display device 201 may be, for example, a liquid crystal display (LCD), an organic light emitting diode (MED), active-matrix organic light emitting diode (AMOLED), a Super AMOLED, a thin film transistor (TFT) light emitting diode (LED), or an in-plane switching (IPS) LED.

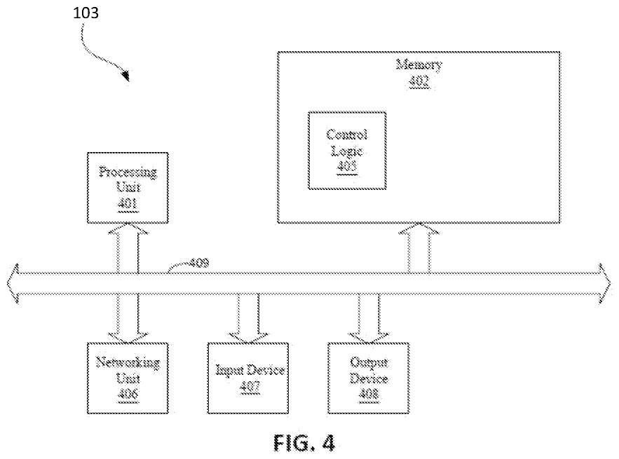

FIG. 4 is a block diagram of a remote computing device 103 (FIG. 1). Note that the remote computing device 103 may be a smartphone. However, other types of remote computing device 103 may be other types of devices in other embodiments. For example, the remote computing device 103 may be a computer, laptop, tablet, or other type of computing device.

The remote computing device 103 comprises a housing (not shown) Further, the remote computing device 103 comprises a display (not shown).

The remote computing device 103 receives data indicative of an invitation to participate in a photograph merge. When the invitee user elects to participate, the remote computing device 103 provides details of the picture, for example a dress code, a body part, special notes, a time, and a date.

Using an input device, the invitee user photograph after a countdown that he/she desires to be in the merged photograph (not shown). Thus, in the final merged photograph, the invitee user's photograph will be in the merged photograph.

Once the invitee user takes a photograph with which the invitee user is satisfied, the invitee user selects a “Send” button (not shown), which transmits the photograph to the first computing device 102 (FIG. 1). In response, the remote computing device 103 transmits data indicative of the invitee user's selection to the first computing device 102 via the network 101 (FIG. 1).

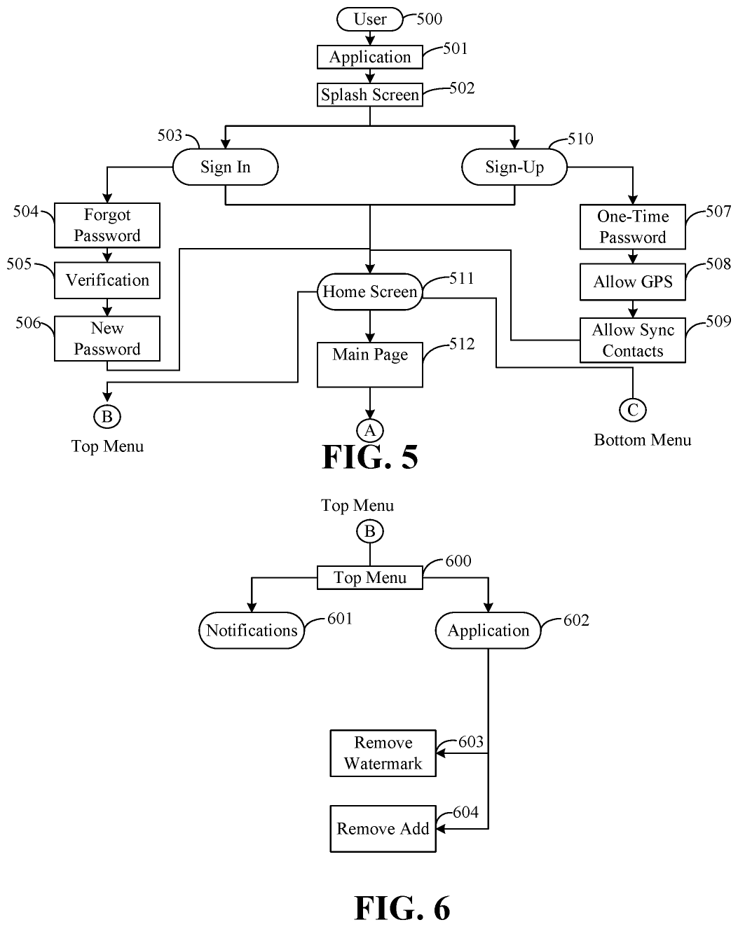

FIG. 5 is a flowchart of exemplary architecture and functionality of the “sign in” module of the first computing device control logic 303 (FIG. 3). In step 500, a host user activates an application in step 501. In response, the control logic 303 displays a splash screen in step 502. From the splash screen, the host user may elect to “Sign In” in step 503 or “Sign Up” in step 510.

If the host user elects to sign in in step 503, the host user enters his/her username and password. If the host user has forgotten his/her password, the host user indicates forgotten password in step 504. The control logic 303 verifies the host user in step 505, and the host user enters a new password in step 506, the control logic 303 navigates the host user to the home screen in step 511.

The host user who does not have a sign in elects the sign-up step 510. The first computing device control logic 303 provides the first computing device a one-time password in step 507, allows global positioning system in step 508, and allows the control logic 303 to synchronize contacts in the host user's contacts.

From signing in or signing up, the control logic 303 navigates the host user to the home screen in step 511. From the home screen the host user can elect to go to the top menu B, the main page A, or the bottom menu C.

FIG. 6 is a flowchart of exemplary architecture and functionality of the control logic 303 from the top menu B. At the top menu in step 600, the host user can elect to check notifications in stop 601. Also, the host user can elect to open the application in step 602. In step 603, the host user may remove a watermark from a photograph to remove any other additional material in the photograph in step 604.

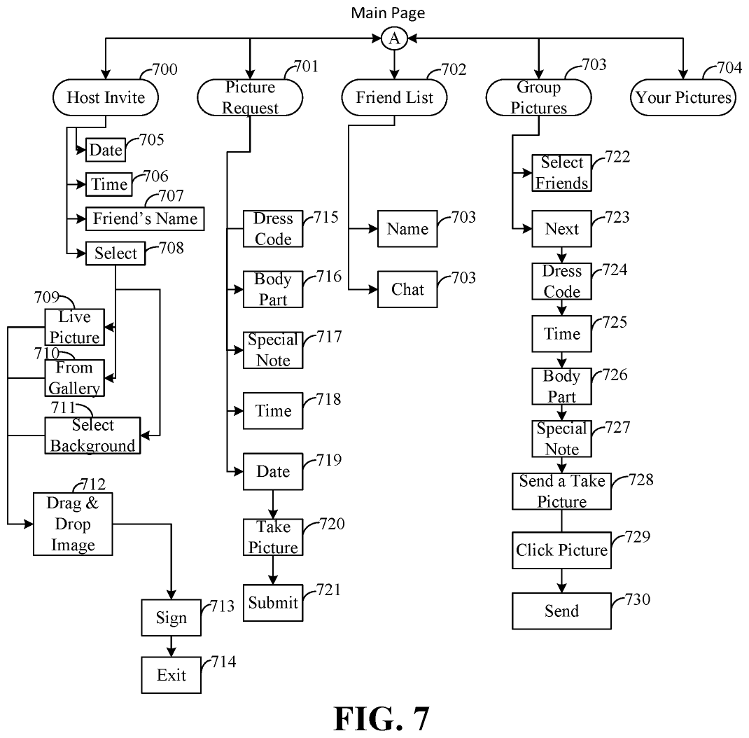

FIG. 7 is a flowchart of exemplary architecture and functionality of the control logic 303 from the main page A. In this regard, from the main page A, the host user may elect to host an invitation in step 700, make a picture request in step 701, view his/her friend list in step 702, group pictures in step 703, and your pictures in step 704.

Your pictures in step 704, if selected, displays to the host user all the photographs that the host user has generated using the application. Thus, the host user can select on a photograph to fully view the photograph.

In the group pictures step 703, the host user creates group pictures. That is, in step 722, the host user selects the friends that the host user desires to be in a merged photograph.

Upon selection of “Next” in step 723, the host user can select details about the picture that he/she desires. For example, the host user may select a dress code in step 724, set the time for taking the picture in step 725, identify the body part the host user desires in the photograph in step 726, and provide special notes in step 727.

The first computing device control logic 303 sends a message to the friends selected to take a photograph. In one embodiment, the message contains the details as described above.

In step 729, the invitee user of the second computing device 103 clicks a picture based on the message received. The second computing device control logic 405 sends the photograph to the first computing device 102.

In step 702, the host user can elect to view his/her friend list. The host user identifies a name of a friend in step 703 to locate the friend. In step 703, the host user can chat with the invitee user.

In step 701, the host user may elect a picture request. The host user may identify a dress code in step 715, a body part in step 716, special notes in step 717, a time for taking the photograph in step 718, and a date in step 719. The invitee user receives the information related to the photograph, and in step 720 takes a picture, the control logic 405 of the second computing device submits the photograph to the invitee user.

In step 700, the host user can host an invite. In this regard, the host user can identify a date in step 705, a time in step 706, and a friend's name in step 707. The host user selects in step 708 a photography of a live picture in step 709 and a photograph from a gallery of photographs. The host user then selects a background for the picture in step 711. The host user can drag and drop images in step 712, sign the photograph in step 712, and exit the application in step 714.

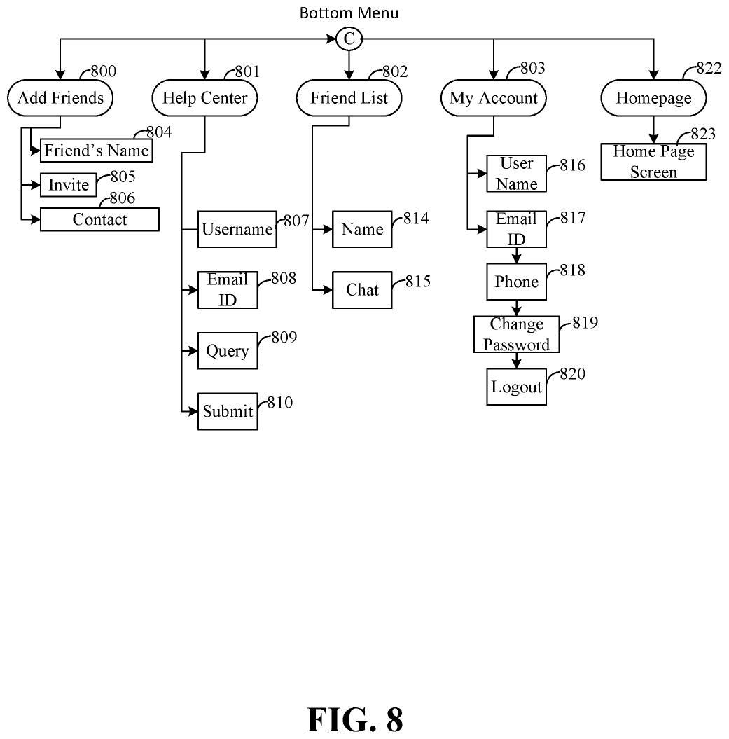

FIG. 8 is a flowchart of exemplary architecture and functionality of the control logic 303 from the bottom menu C. From the bottom menu C, the host user selects add friends 800, help center 801, friend list 802, my account 803, and homepage 822.

The host user can select the homepage 822 from the bottom menu C. From the homepage 822, the host user can elect to display the home page screen in step 823.

In step 803, the host user can elect my account 803 from the bottom menu C. The account election allows the host user to manage his/her username in step 816, email identification in step 817, phone number in step 818. The host user can change his/her password in step 819, and the host user can logout of the application in step 820.

In step 802, the host user can elect friend list 802. The host user can view his/her friends by searching on the friend list. Also, the host user can elect to chat with a friend in the friend list in step 815.

In step 801, the host user can elect help center. The help center can provide the host user with help related to his/her username in step 807, email identification in step 808, draft a help query in step 809, and submit a query in step 810.

In step 800, the host user can elect to add friends. The host user adds a friend's name in step 804, invites the friend to participate in the application in step 805, and contacts the friend in step 806.

What we claim is:

1. A system, comprising:
a first computing device;
a second computing device communicatively coupled to the first computing device via a network; and
a processor on the first computing device operated by a host user and configured for sending an invitation to an invitee user to take a picture of himself/herself by a host user, the processor further configured to receive a first photograph from the invitee user and merge the first photograph of the invitee user with a second photograph of the host user creating a merged photograph, the processor further configured to share the merged photograph with other invitee users or social media.

2. The system of claim 1, wherein the processor is further configured to display one or more backgrounds.

3. The system of claim 2, wherein the processor is further configured to receive a selection of one of the one or more backgrounds.

4. The system of claim 3, wherein the processor is further configured to digitize the selected background and adds the selected background to the merged photograph.

5. The system of claim 1, wherein the processor is further configured to receive data indicative of a drag and drop of the first photograph and the second photograph to generate the merged document.

6. The system of claim 1, wherein the first computing device and/or the second computing device are smartphones, computers, laptops, or tablets.

7. The system of claim 1, wherein the host user chooses the first photograph from a live picture.

8. The system of claim 1, wherein the host user chooses the first photograph from a gallery.

9. The system of claim 1, wherein the processor is further configured to receive a signature and place the signature on the merged photograph.

10. The system of claim 1, wherein the processor is further configured to place a watermark on the merged photograph.

11. The system of claim 1, wherein the processor receives input from the host user data indicative of a dress code, a body part, special notes, date, and/or a time.

12. The system of claim 11, wherein the invitation comprises data indicative of a dress code, a body part, special notes, date, and/or a time.

13. The system of claim 12, wherein the processor is further configured to enable a chatroom such that the host user may chat with the invitee user and/or a plurality of friends.

14. The system of claim 1, wherein the processor is further configured to send a plurality of invitations to a plurality of friends.

15. The system of claim 14, wherein the processor is further configured to receive friend photographs from the plurality of friends.

16. The system of claim 15, wherein the processor is further configured to generate the merged photograph with the friend photographs from the plurality of friends.
